(19) United States
(12) Patent Application Publication
(10) Pub. No.: US 2010/0077155 A1
(43) Pub. Date: Mar. 25, 2010

(54) Managing shared memory through a kernel driver

(76) Inventor: Joseph Chyam Cohen, Burbank, CA (US)

Correspondence Address: Albert R. Ubieta;Torrey Pines Intellectual Property Group, P.C., No. 431, 2658 Del Mar Heights Road, Del Mar, CA, 92014, US

(21) Appl. No.: 12/586,616

(22) Filed: Sep. 23, 2009

Related U.S. Application Data
(60) Provisional application No. 61/099,474, filed on Sep. 23, 2008.

(51) Int. Cl. G06F 12/00; G06F 9/44

(52) U.S. Cl. 711/147; 719/312; 711/E12.001

(57) ABSTRACT

Methods, apparatus, systems and computer program product for managing shared memory between a plurality of applications. A kernel driver can create a region of shared memory and then map this memory into each application that requests access to this specific memory. The kernel driver can separate the entire memory into multiple shared memory sections, regions and/or pools, each of which exists independently from each other, thereby maintaining security between applications. The kernel driver can create a claim ticket containing information about the storage location of shared data; this ticket may then be passed to, from and between a plurality of applications needing to access the shared data.

### CROSS-REFERENCE TO RELATED APPLICATIONS

This application claims the benefit of provisional patent application Ser. No. 61/099,474, filed Sep. 23, 2008, which is incorporated by reference.

### FEDERALLY SPONSORED RESEARCH

Not applicable.

### SEQUENCE LISTING OR PROGRAM

Not applicable.

### FIELD OF THE INVENTION

The present invention relates to the field of computer networks. In particular, the present invention relates to methods, apparatus, systems and computer program product for managing shared memory between a plurality of applications.

### BACKGROUND

Contemporary computer operating systems typically provide applications a method of sharing access to a section of memory when multiple applications are running on the system. Through the use of a defined region or section of memory, applications can share large amounts of data, thereby reducing physical system requirements and allowing multiple programs to access and/or manipulate the stored data simultaneously or synchronously. Various operating systems have specific programming interfaces to create, manage and destroy this shared memory. For instance, some systems use APIs such as shm_open, mmap or MachVM. Other common APIs include shmget, shmat, shmctl and ftok. Each of these APIs, and their related operating system, has its own advantages and disadvantages. For example, many of these APIs cannot share a region of memory that already contains data, as the process of creating or identifying a shared memory region results in the destruction of any data already stored in that region. Other known methods, such as MachVM, are dependent on a kernel's virtual memory manager, causing them to be operating-system specific. Despite the availability of these interfaces, a need exists for improved memory management that allows better security, better resource management and faster, more robust operation.

### SUMMARY

The disclosed embodiments relate to methods, apparatus, systems and computer program product for managing shared memory between a plurality of applications. In accordance with a preferred embodiment, the disclosed methods, apparatus, systems and computer program product provide rapid and robust sharing of data generated by one application with one or more other applications. The disclosed embodiments allow the plurality of applications accessing the shared memory to run asynchronously and to communicate quickly. As a result of the disclosed embodiments, modified data or information identifying modified data in a shared memory can be sent in real-time. In one embodiment, a kernel driver creates a shared memory and then maps this memory into each application that requests access to this specific memory. This driver is able to separate the entire memory into multiple shared memory sections, regions and/or pools, each of which exists independently from each other, thereby maintaining security between applications. In one preferred embodiment, a kernel driver can create a claim ticket containing information about the storage location of shared data. This ticket may then be passed to, from and between a plurality of applications needing to access the shared data. The disclosed embodiments provide an improved means for this sharing of memory to occur.

### DRAWINGS

The accompanying drawings, which are incorporated in and constitute a part of this specification, illustrate embodiments of the invention and together with the description serve to explain the principles of the invention.

FIG. 1 graphically depicts an exemplary application environment that includes a plurality of architectural elements configured to provide and manage access to shared memory.

FIG. 2 is a flow chart of an exemplary process for sharing memory.

FIG. 3 graphically depicts an exemplary system for referencing memory locations in system memory.

### DETAILED DESCRIPTION

Exemplary embodiments of the present invention are now described in detail, including depiction of the hardware components which serve as the context for the process embodiments.

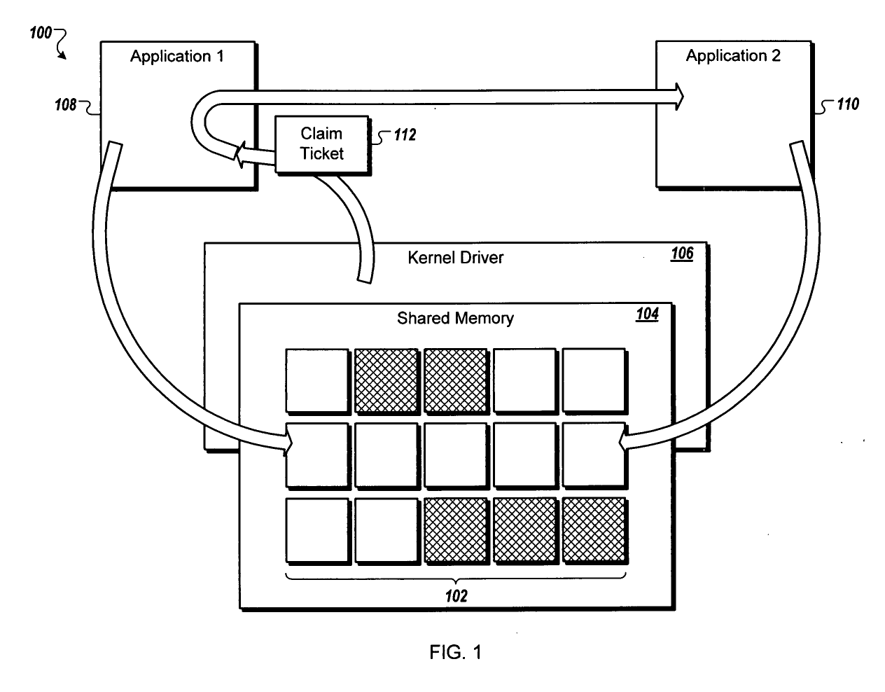

FIG. 1 shows an example application environment 100, which includes a plurality of architectural elements configured to provide and manage access to shared memory. The shared memory can be utilized by one or more applications without first being prepared for sharing. For example, the memory can be shared by two or more applications executing in the application environment 100 without first having to erase the data stored in the shared memory. Further, the memory can be accessed via a reference to an index, thereby reducing the chance of failure.

In the application environment 100, the shared memory 104 can include a plurality of memory pages 102. The application environment also can include a kernel driver 106, and a plurality of applications 108 and 110. A claim ticket 112 can be used to pass a reference to a memory location. The application environment 100 can be hosted in any suitable computing architecture, such as a desktop computer, a laptop computer, a palm top computer, a server, a mobile communications device, and an embedded computing system. Further, the application environment 100 can be implemented in an operating system, such as a Mac OS provided by Apple Inc. of Cupertino, Calif., a Windows operating system provided by Microsoft Corporation of Redmond, Wash., or a Linux operating system. Other configurations of the application environment 100 are possible.

The memory pages 102 can be configured as a logical assignment of storage locations included in one or more physical memory structures available to the application environment 100. In some implementations, the physical memory can be collected and indexed so that the application environment 100 can utilize the storage locations regardless of the physical memory characteristics. The shared memory 104 is a collection of the memory pages 102 that can be shared between two or more applications, such as the applications 108 and 110.

The kernel driver 106 can be implemented as one or more objects, modules, processes, or a combination thereof that support the sharing of the memory pages 102. Further, the applications 108 and 110 represent two applications that can execute in the application environment 100 and can access the shared memory 104. The applications 108 and 110 are described to illustrate memory sharing. However, it is appreciated that any number of applications can be associated with the application environment 100 and can participate in memory sharing. Additionally, the claim ticket 112 can be an object, data, a file, or other logical and/or physical construct that can facilitate accessing the shared memory 104. In some implementations, the data used to share one or more memory pages 102 can be coded or obfuscated to protect the application environment 100 as well as the operating system from malicious attacks and/or to lower the chance of a corrupted claim ticket referencing a memory location that is not intended to be shared.

In an example, the application 108 can be an application program that performs one or more resource intensive functions, such as complex mathematical analysis. For instance, the application 108 can compute the heat transfer properties of a piece of metal. Further, the application 110 can utilize data generated by the application 108. For example, the application 110 can render the heat transfer data generated by the application 108 into a color coded image that can be displayed. Use of the shared memory 104 can allow the applications 108 and 110 to both run asynchronously and to communicate quickly. For example, the application 108 can begin processing data and can store the processed data in the shared memory 104, using one or more of the memory pages 102. Further, a portion of the shared memory 104 can be flagged such that when one application sharing the portion of memory alters the stored data, the modified data can be provided to one or more other applications that also are sharing the data. In some implementations, information identifying the modified data can be sent to one or more other sharing applications. Additionally, the modified data or information identifying the modified data can be sent in real-time.

The kernel driver 106 can create a claim ticket 112 that contains information about the location of the stored data. One or more claim tickets can be generated depending on the data being stored. Once generated, the application 108 can pass the claim ticket 112 to the application 110. While the application 108 continues to store heat transfer data in the shared memory 104, the application 110 can use the claim ticket 112 to access the corresponding portion of the shared memory 104 to retrieve the stored heat transfer data for use in generating an image.

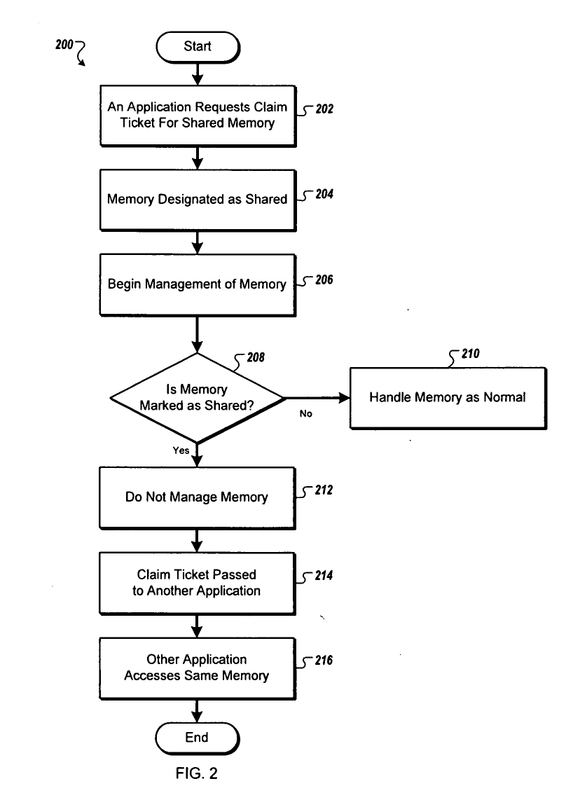

FIG. 2 shows an example process that can be executed to share memory. An application, such as the application 108 or 110, can request a claim ticket associated with a location in the memory (202). The request indicates to the operating system or application environment that the corresponding memory can be designated as shared memory (204) that can be accessible to multiple applications. In some implementations, an optimization or clean-up procedure can be performed on one or more portions of the memory. The operating system can protect the portions identified as shared memory to prevent those portions from being altered by any system processes. Thus, the information stored in a portion of shared memory referenced by the corresponding claim ticket remains valid.

The operating system protects the shared memory to prevent any inadvertent relocation or destruction of data during memory management (206). To prevent the inadvertent relocation or destruction of shared data, the operating system can determine whether a portion of the memory had been marked as shared (208). If a portion of the memory has not been marked as shared, it can be processed by the operating system, including clean-up and optimization processes. If, however, a portion of memory has been marked as shared memory, one or more memory management functions, such as the optimization process, can be suspended for that portion (212). Further, the application that requested the claim ticket can pass the claim ticket to a receiving application (214). The receiving application can then use the claim ticket to access the shared memory (216) to perform one or more operations on the stored data. Because the shared memory has been protected from optimization and clean-up procedures, the receiving application can be sure that the data in the shared memory has not been changed by a memory optimization process.

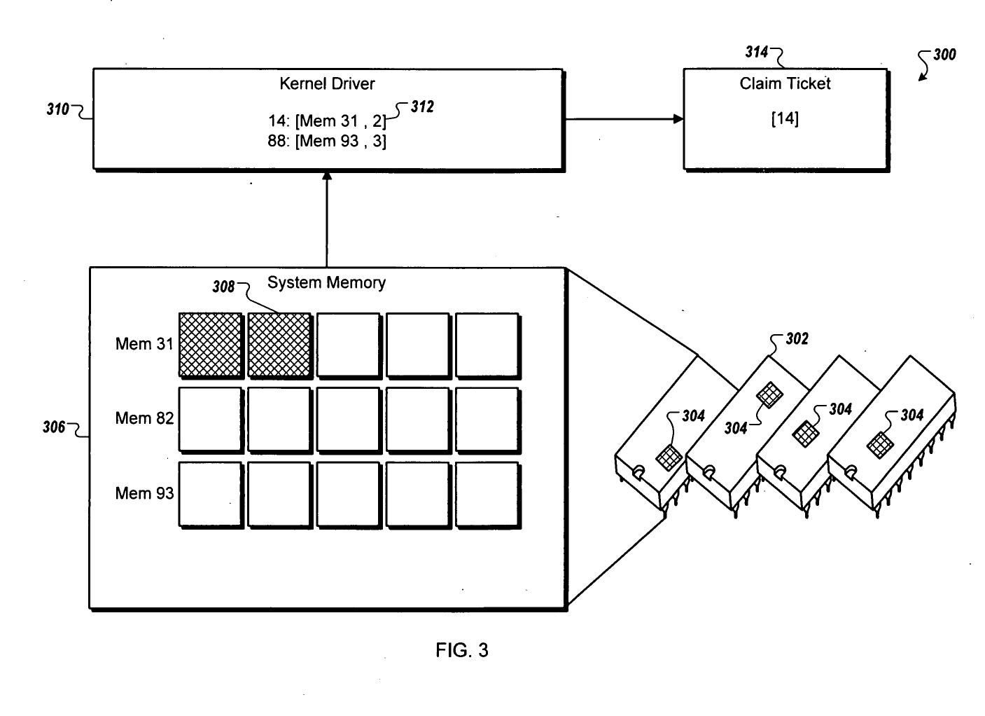

FIG. 3 is an example block diagram of a system for referencing memory locations in system memory. The memory system 300 generates an identifier that can be resolved using an index corresponding to one or more physical memory locations, which can be complex or can differ from one hardware configuration to the next. The memory system 300 can include physical memory 302, physical memory locations 304, a system memory 306, one or more memory pages 308, a kernel driver 310, a memory index 312, and a claim ticket 314.

The physical memory 302 can be any memory structure that is used to store data, including volatile and non-volatile memory structures. In some implementations, the physical memory 302 can include a plurality of memory devices (or modules). It will be appreciated that there are many possible configurations of the physical memory, including a single memory device, multiple memory devices, a portion of one or more memory devices, or any combination thereof. Each addressable portion of the physical memory 302 can be identified as a physical memory location 304. The physical memory locations 304 can be organized to define one or more memory pages 308. For example, an operating system or application environment managing the physical memory 302 can organize and manage the memory pages 308. Further, the one or more memory pages 308 can be made available for use as system memory 306. When made available as system memory 306, addresses can be assigned for each of the memory pages 308. The one or more memory pages 308 can be created from the same number of, greater, or fewer physical memory locations 304. Additionally, one or more software tools, such as Universal Pages Lists (UPL), the Unix environment program pmap, and the X is not Unix (XNU) environment programs MachVM and VM can be used to map the system memory 306 to the physical memory locations 304.

The kernel driver 310 can be implemented as a software object, such as a file or an object-oriented software module that includes a memory index 312. The memory index 312 can contain the addresses of the one or more memory pages 308 corresponding to the system memory 306. The memory index 312 can be configured to implement any memory addressing convention or system. Further, the memory index 312 can be used to generate one or more claim tickets. A claim ticket 314 can include a key that can be used to look up an entry in the memory index 312, such as to resolve an address of a memory page 308. A claim ticket can then be passed to one or more receiving applications, which can use the claim ticket to access the corresponding portion of shared memory.

In one example, a claim ticket 314 can contain the value “[14]”. The value “[14]” included in the claim ticket 314 can correspond to an entry in the memory index 312, which further can identify one or more memory pages 308. For example, the entry corresponding to the value [14] in the memory index 312 can specify [Mem 31, 2], indicating a location starting at memory page 31 and consisting of two pages of the system memory 306. Thus, a receiving application can use the claim ticket to access the memory pages starting at page 31.

The embodiments described above are given as illustrative examples only. It will be readily appreciated by those skilled in the art that many deviations may be made from the specific embodiments; accordingly, the scope of the invention is to be determined by the claims below rather than being limited to the specifically described embodiments above. In addition, the flowcharts found in the figures are provided to instruct a programmer of ordinary skill to write and debug the disclosed embodiments without undue effort; the logic flow may include other steps and the system other components. The invention is not limited to a particular expression of source or object code. Accordingly, other implementations are within the scope of the claims.

What is claimed:

1. A method of sharing memory between a plurality of applications, the method comprising:
identifying a portion of memory to be shared, wherein the portion of memory does not have to be prepared by a memory manager;
generating a claim ticket corresponding to the portion of memory;
protecting the portion of memory against alteration by the memory manager; and
transmitting the claim ticket to one or more receiving applications to share the portion of memory.

2. The method of claim 1, further comprising accessing the portion of memory via reference to an index.

3. The method of claim 2, further comprising generating an identifier, to be resolved via the index, corresponding to one or more physical memory locations.

4. The method of claim 1, further comprising flagging an altered portion of the shared memory when one of the plurality of applications alters a data entry stored in the portion of shared memory.

5. The method of claim 4, further comprising sending information identifying the altered portion of memory to one or more other said applications sharing that portion of memory.

6. A computer system comprising one or more processing elements and a physical memory capable of storing data,
wherein the one or more processing elements are programmed or adapted to perform the steps comprising:
identifying a portion of the memory to be shared, wherein the portion of memory does not have to be prepared by a memory manager;
generating a claim ticket corresponding to the portion of memory;
protecting the portion of memory against alteration by the memory manager; and
transmitting the claim ticket to one or more receiving applications to share the portion of memory.

7. The system of claim 6, further comprising one or more processing elements programmed or adapted to perform the step of accessing the portion of memory via reference to an index.

8. The system of claim 7, further comprising one or more processing elements programmed or adapted to perform the step of generating an identifier, to be resolved via the index, corresponding to one or more physical memory locations.

9. The system of claim 6, further comprising one or more processing elements programmed or adapted to perform the step of flagging an altered portion of the shared memory when one of the plurality of applications alters a data entry stored in the portion of shared memory.

10. The system of claim 9, further comprising one or more processing elements programmed or adapted to perform the step of sending information identifying the altered portion of memory to one or more other said applications sharing that portion of memory.

11. A tangible computer-readable storage media comprising stored instructions that, upon execution by a programmable processor, are operable to cause the programmable processor to perform the method of claim 1.
